(19) United States
(12) Patent Application Publication
(10) Pub. No.: US 2024/0035922 A1
(43) Pub. Date: Feb. 1, 2024

(54) SYSTEM FOR DETERMINATION OF FLIGHT PERFORMANCE OF BIOINSPIRED AERIAL VEHICLE IN SIMULATED SPACE CONDITIONS

(71) Applicants: NMICPS - Technololgy Innovation Hub on Autonomous Navigation Foundation (TiHAN), Sangareddy (IN); Indian Institute of Technology (IIT) Hyderabad, Sangareddy (IN)

(72) Inventors: Rajalakshmi PACHAMUTHU, Sangareddy (IN); Naga Praveen Babu MANNAM, Sangareddy (IN); Prasanth Kumar DUBA, Sangareddy (IN)

(21) Appl. No.: 17/981,424

(22) Filed: Nov. 6, 2022

(30) Foreign Application Priority Data
Jul. 29, 2022 (IN) 202241043483

(51) Int. Cl. G01M 9/06; B64C 33/02; B64C 39/02; B64D 27/24; B64D 9/00; H04N 5/272

(52) U.S. Cl. CPC G01M 9/06; B64C 33/02; B64C 39/024; B64D 27/24; B64D 9/00; H04N 5/272; B64C 2201/025; B64C 2201/127; B64C 2201/128; B64C 2201/042

(57) ABSTRACT

A system (100) for determination of flight performance of the bioinspired flapping-wing aerial vehicle (101) in simulated space conditions discloses the aerial vehicle (101) installed in a thermo-vacuum chamber (103) that maintains vacuum and temperature for aerial vehicle (101) to simulate climatic conditions in space, where the aerial vehicle (101) is evaluated by the force transducer (104) and data acquisition system (105) acquires the data from force transducer (104). The flapping motion of the wing (101b) of the aerial vehicle (101) in space conditions increases the velocity of aerial vehicle (101), where dynamic wing twisting maintains the wing (101b) at a specific angle of attack to generate lift force and wing deformation occurs during which the passive pitch angle produces high lift forces, facilitating stable flight in simulated space conditions.

### PREAMBLE TO THE DESCRIPTION

The following specification particularly describes the invention and the manner in which it is to be performed:

### DESCRIPTION OF THE INVENTION

### Technical Field of the Invention

The present invention relates generally to the field of aerospace technology, and particularly to a system for determination of flight performance of bioinspired flapping-wing aerial vehicle in simulated space conditions.

### Background of the Invention

In recent years, various devices have been designed and developed to perform planetary exploration, wherein planetary exploration aircraft is regarded as a viable science platform leading to the most significant technological advancements. These aircraft fill a unique measurement gap in planetary science, mineral exploration, and near-surface observation, offering a novel outlook on planetary discovery.

Most space investigation vehicles consist of specific vehicular platforms. There are various ways other than sending astronauts to study space objects, including the use of telescopes and satellites, robots and rovers. Rovers are preferred for planetary explorations, using the terrain mapping of the regions to be explored. The drawbacks of using rovers are that they are usually restricted in speed and maneuverability and the structure and slope of any terrain. Further, these drawbacks limit the use of rover to fewer places and efficient planning is required to increase the number of regions being explored. When the terrain is excessively rough, the rover cannot access most of these critically important regions.

In order to overcome the drawbacks of rover, the use of micro/nano unmanned aerial vehicles (UAVs) has increased, where the fixed wings aircraft capable of performing forward motion uses different technologies such as glider, propeller, and rocket-propelled to generate the lift. As the size of micro/nano unmanned aerial vehicles (UAVs) are reduced, they face complex unsteady aerodynamic characteristics, which have to be resolved. The fixed-wing aircraft and rotorcraft, has several disadvantages over flapping-wing aircraft in terms of maneuverability, lower noise, and better stealth. The unsteady aerodynamic forces are relative to the density of fluid properties; traditional terrestrial aircraft designs create inadequate lift in low gravity atmospheres.

The fixed-wing and rotorcraft lift coefficients are significantly reduced in the low Reynolds number (Re) range and manmade efforts to develop bioinspired aerial vehicles have several drawbacks to be addressed in order to perform complex tasks in space exploration methods. Further, other challenges include design and fabrication challenges, flight tests, deployment and planet entry, and various navigation and control approaches.

The Patent application number CN20142810876U titled “Aerodynamic force testing device for miniature flapping wing aircraft” discloses an aerodynamic force testing device for a miniature flapping wing aircraft, comprising the miniature flapping wing aircraft, a vacuum box shell body, a rotary vane type vacuum pump, a supporting rod, a dynamometric installation plate, a dynamometric sensor, a sensor installation plate and the like, wherein the miniature flapping wing aircraft flaps wings in the vacuum box shell body, and an aerodynamic force is obtained through detecting difference between acting forces exerted on the miniature flapping wing aircraft in the vertical direction under vacuum conditions and normal conditions. The aerodynamic force testing device can test the accurate aerodynamic force generated when flapping wings flap in a quantitative mode, and can measure the force variation in real time under the condition of given flapping frequency.

The Patent application number CN202110537595 titled “Experimental device and experimental method for measuring limit flight capability of flapping-wing aircraft” discloses an experiment device and an experiment method for measuring the limit flight capability of a flapping wing aircraft. The device comprises an experiment table, the experiment table is covered with a glass cover, the experiment table and the glass cover are matched to form a sealing cavity, and the sealing cavity is communicated with a vacuum adjusting system through a pipeline. A pressure sensor matched with the vacuumizing adjusting system is arranged on the experiment table in the sealing cavity; a fixing support is further arranged on the experiment table in the sealing cavity, a lift force sensor is fixedly arranged on the fixing support and matched with the flapping-wing aircraft; the lift force sensor, the pressure sensor and the flapping-wing aircraft are all matched with a central controller, and the central controller is used for displaying lift force and air pressure and adjusting the flapping frequency of the flapping-wing aircraft. A high-altitude/high-temperature/high-humidity environment is simulated based on the experimental device, the flight height limit and the maximum flight acceleration of the ornithopter can be tested without actual flight, and an experimental test basis is provided for design and optimization of the flapping-wing aircraft.

The Patent application number CN201610308863 titled “Observation system and method for aerodynamic force test and flapping wing flow field of flapping-wing micro air vehicle” provides an observation system and method for an aerodynamic force test and a flapping wing flow field of a flapping-wing micro air vehicle. The system comprises an observation box, a flapping-wing micro air vehicle, an aerodynamic force testing device, a three-dimensional particle image velocity measuring device, and an upper computer. The observation box is used for accommodating an observation object and an observation device. The flapping-wing micro air vehicle is used as an observation object for observation. The aerodynamic force testing device is used for recording various parameters of aerodynamic force characteristics of the flapping-wing micro air vehicle during the flapping process. The three-dimensional particle image velocity measuring device is used for recording various parameters of flapping-wing flow field characteristics of the flapping-wing micro air vehicle during the flapping process. The upper computer is used for displaying a lifting resistance parameter, a flapping frequency parameter, and a flow field characteristic analysis chart of the flapping-wing micro air vehicle. The method includes a step of carrying out aerodynamic force characteristic observation by using an aerodynamic force testing device and a step of carrying out flapping wing flow field characteristic observation by using the three-dimensional particle image velocity measuring, device.

There is a need for a system that overcomes the drawbacks of the existing systems and the prior arts, to provide a system to determine the flight performance of the bioinspired flapping-wing aerial vehicle in simulated space conditions and a bioinspired flapping-wing aerial vehicle that operates at low density, low gravity, and low Reynolds number atmospheric conditions. Further, there is a need for a system to facilitate planetary exploration, helping to explore the desired area in space, thus potentially reducing environmental damage in a planetary atmosphere.

### SUMMARY OF THE INVENTION

The present invention overcomes the drawbacks of the prior art by disclosing a system for determination of flight performance of a bioinspired flapping-wing aerial vehicle that investigates the wing trajectory and dynamics, and wing kinematics in simulated space conditions. The bioinspired flapping-wing aerial vehicle comprises an image capturing device to capture images and video, at least one wing to facilitate movement of the aerial vehicle, a gear drive mechanism and a power source to drive the flapping motion of the wing, a servo-controlled tail to provide enhanced maneuverability to the aerial vehicle and a housing to carry at least one payload such as an inertial measurement unit.

According to the present invention, the flapping motion of the wing of the bioinspired flapping-wing aerial vehicle is driven by a gear drive mechanism in which the gears are shifting in size based on the desired flapping rate, where the gears are fused parallel to the spine or fuselage. The crank arm assembly creates an asymmetric flapping angle at the root of the wing with the maximum stroke angle being higher than the minimum stroke angle. The pectoralis muscles of the flapping-wing aerial vehicle power the rotation around the universal shoulder joint, to facilitate the flapping motion, feathering motion and lead-lag motion.

The system for determination of wing trajectory and dynamics, kinematics and aerodynamics of the bioinspired flapping-wing aerial vehicle in simulated space conditions, comprises a bioinspired flapping-wing aerial vehicle, a data logging and processing unit to record the waveform data captured by the image capturing device and process the captured data. The system discloses a thermo-vacuum chamber to accommodate the flapping-wing aerial vehicle, where the thermo-vacuum chamber simulates the climatic conditions of space by adjusting the pressure and temperature parameters, thus facilitating evaluation of the wing kinematics. The force transducer connected to the thermo-vacuum chamber converts the input mechanical force of the wing into a measurable output which is acquired by a data acquisition system. The system evaluates the flapping wing kinematics of the bioinspired flapping-wing aerial vehicle, where the kinematics of a flapping wing is examined using kinematic data in both simulated space conditions and earth ambient conditions.

Further, the system measures the forces and moments of the bioinspired flapping-wing aerial vehicle in simulated space conditions for a range of flapping frequencies. The bioinspired flapping-wing aerial vehicle is evaluated in various physical constraints, where the aerial vehicle accurately replicates the flight motions of birds in simulated space conditions and its kinematics in simulated space conditions in a range of flapping frequencies enables the aerial vehicle to operate efficiently in low Reynolds number environments.

There are several advantages of the present invention including good propulsion, maneuverability, and harvesting renewable energy. Further, the bioinspired flapping-wing aerial vehicles are suitable for low-altitude surveillance, terrain mapping, swarming capabilities, inspection, and planetary exploration. The bioinspired flapping-wing aerial vehicles operate efficiently at low Reynolds number environments, thus creating a better aerodynamic behavior in space conditions.

Further, another advantage of using the bioinspired flapping-wing aerial vehicle is that, the flapping wings control the motion of the aerial vehicle and generates adequate lift and thrust forces and the tail fin on the aerial vehicle controls pitching and yawing motions.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates the schematic diagram of flight performance determination system in simulated space conditions.

FIG. 2 illustrates the isometric view of the bioinspired flapping-wing aerial vehicle.

FIG. 3 illustrates a schematic diagram disclosing the components of the bioinspired flapping-wing aerial vehicle.

FIG. 4 illustrates a flow diagram disclosing the method involved in determination of flight performance of the bioinspired flapping wing aerial vehicle.

FIG. 5 illustrates a graphical representation of the vertical displacement of the flapping wing in high vacuum and earth ambient conditions.

FIG. 6 illustrates a graphical representation of the horizontal displacement of the flapping wing in simulated space conditions and earth ambient conditions.

FIG. 7 illustrates a graphical representation of the change in velocity of the flapping wing in simulated space conditions and earth ambient conditions.

FIG. 8 illustrates a graphical representation of the change in moving distance of the flapping wing in simulated space conditions and earth ambient conditions.

FIG. 9 illustrates the graphical representation of estimation of thrust Force (Fₓ) of the flapping wing in simulated space conditions and earth ambient conditions.

FIG. 10 illustrates the graphical representation of variation of force about y-axis of the flapping wing in simulated space conditions and earth ambient conditions.

FIG. 11 illustrates the graphical representation of variation of force about z-axis of the flapping wing in simulated space conditions and earth ambient conditions.

FIG. 12 illustrates the graphical representation of Moment about x-axis in simulated space conditions and earth ambient conditions

FIG. 13 illustrates the graphical representation of Moment about y-axis in simulated space conditions and earth ambient conditions

FIG. 14 illustrates the graphical representation of Moment about z-axis in simulated space conditions and earth ambient conditions

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention. The terms “bioinspired flapping-wing aerial vehicle”, “flapping-wing aerial vehicle” and “aerial device” may be interchangeably used. Further, the terms “aerodynamic forces” and “lift and thrust forces” are interchangeably used.

The present invention discloses a system for determination of flight performance in three-dimensional space conditions across time, and physical deformation of the wing of a bioinspired flapping-wing aerial vehicle during entire flapping time.

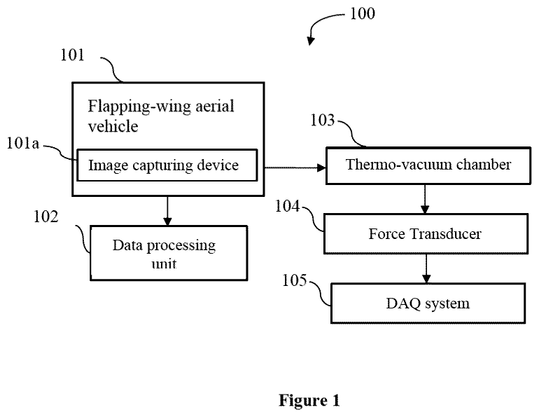

FIG. 1 illustrates the schematic diagram of a system (100) to determine the flight performance of the bioinspired flapping wing aerial vehicle. The system (100) discloses the flapping-wing aerial vehicle (101) comprising an image capturing device (101a) facilitating imaging and videography, which is connected to a data logging and processing system (102) having one or more channels of analog signals to record and process the data captured by the image capturing device (101a). The image capturing device (101a) records video and the data logging and processing system (102) records the data waveforms, and synchronizes the waveforms such as voltage, current, pressure, and vibration, that are overlaid on video and viewed on the built-in monitor of the system (100).

The system (100) further discloses a thermo-vacuum chamber (103) comprising a custom stand to accommodate the aerial vehicle (101), where the thermo-vacuum chamber (103) maintains required vacuum and temperature to simulate the climatic conditions in space. The thermo-vacuum chamber (103) facilitates performing satellite performance tests, thermal cycle control, and testing of components, subsystems in a controlled environment. The thermo-vacuum chamber (103) enables testing in space conditions through simultaneous control of the pressure and temperature.

The system (100) further discloses the force transducer (104) connected to the thermo-vacuum chamber (103), that converts the input mechanical force such as pressure into an electrical output signal that can be measured. The performance of the force transducer (104) and output data is captured using data acquisition system (105), which is used for measurement of thrust force.

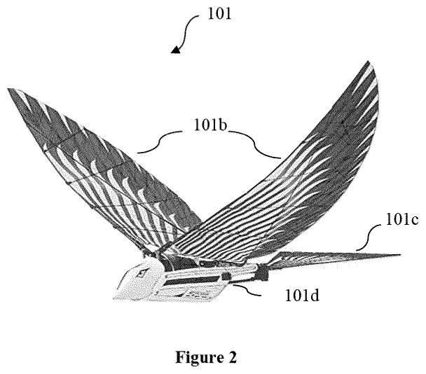

FIG. 2 illustrates the isometric view of the bioinspired flapping-wing aerial vehicle (101). The aerial vehicle (101) comprises at least one wing (101b) which exhibits the flapping motion, wherein the wing (101b) uses dynamic wing twisting to maintain the wing (101b) at a specific angle of attack, facilitating generation of lift force. The aerial vehicle (101) discloses a servo-controlled tail (101c) to perform balancing, steering, and braking functions that enhances lift force of the aerial vehicle (101) during low-speed flights. The servo-controlled tail (101c) provides enhanced maneuverability to the aerial vehicle (101). The aerial vehicle (101) further discloses a housing (101d) to accommodate at least one payload such as inertial measurement unit. The housing (101d) and the landing gear of the aerial vehicle (101) are lightweight and have low air resistance during flight.

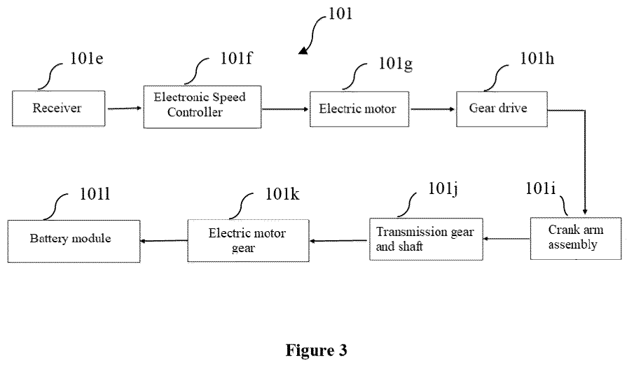

FIG. 3 illustrates a schematic diagram disclosing the components of the bioinspired flapping-wing aerial vehicle (101). The aerial vehicle (101) discloses a receiver (101e) to receive signal from an electronic speed controller (101f) to control the speed of the wings (101b) of the aerial vehicle (100). An electric motor (101g) supplies power to a gear drive (101h) of the aerial vehicle (100) that drives the flapping motion of the wing (101b), wherein the plurality of gears of the gear drive (101h) shift in size based on the desired flapping rate of the wing (101b). The plurality of gears of gear drive (101h) is fused parallelly to the spine or fuselage of the aerial vehicle (101).

According to the present invention, a crank arm assembly (101i) attached to the gear drive (101h) creates an asymmetric flapping angle at the root of the wing (101b), wherein the asymmetric flapping angle is created with the maximum stroke angle of about 40°, that is five degrees higher than the minimum stroke angle of 35°. The crank arm assembly (101i) transfers the flapping power of the wing (101b) by connecting the wing (101b) to the transmission gear and shaft assembly (101j) of the electric motor gear (101k), which are powered by the battery module (101l).

According to the present invention, the system (100) measures the aerodynamic forces of the aerial vehicle (101) including lift and thrust forces in space conditions. The aerial vehicle (101) is placed in the thermo-vacuum chamber (103), where the temperature and pressure are adjusted to replicate the space conditions. The aerial vehicle (101) is placed on a custom stand in the thermo-vacuum chamber (103), that provides support to the aerial vehicle (101) and enables measurement of the unstable forces produced by aerial vehicle (101) and the flexible deformation of the wings (101b) of the aerial vehicle (101). In one embodiment, the thermo-vacuum chamber (103) has a temperature range of −60° C. to +120° C. and the vacuum range of 1*10⁻⁶ torr.

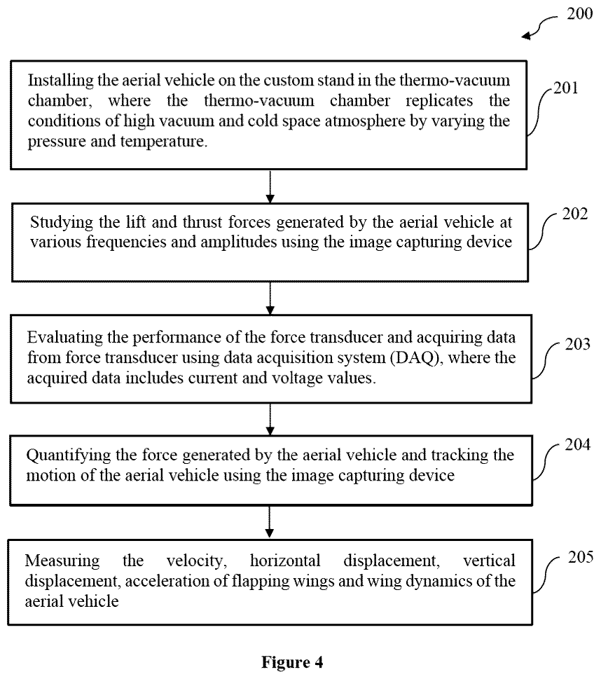

FIG. 4 illustrates a flow diagram disclosing the method involved in determination of flight performance of the bioinspired flapping wing aerial vehicle (101). The method (200) comprises the steps of: installing the aerial vehicle (101) in the thermo-vacuum chamber (103), wherein the pressure inside the chamber maintained to replicate the conditions, of a high vacuum and cold space atmosphere by varying the pressure and temperature in the thermo-vacuum chamber (103) in real-time, as disclosed in step (201). The system (100) is used to study the lift and thrust forces generated by the aerial vehicle (101) at various frequencies and amplitudes using the imaging and videography features of the image capturing device (101a), as disclosed in step (202). In the step (203), the performance of the force transducer (104) is evaluated and the data generated by the force transducer (104) is acquired data acquisition system (DAQ) (105). Further, the current and voltage values for each test are recorded, wherein the voltage values which are observed from at least one retroreflective marker placed on the left wing (101b) of the aerial vehicle (101), with the help of a digital oscilloscope, which displays and analyzes the waveforms of the acquired signals. In the step (204), the force generated by the aerial vehicle (101) is quantified and the motion of the aerial vehicle (101) is tracked using the image capturing device (101a). Further, the velocity, horizontal displacement, vertical displacement and acceleration of flapping foils of the aerial vehicle (101) is measured, as disclosed in step (205).

According to the present invention, the aerodynamic forces i.e., lift force and thrust force of the aerial vehicle (101) are evaluated at various frequencies and amplitudes using the image capturing device (101a), and the current and voltage values are recorded for each test and the voltage values are observed from the retroreflective markers located on the wings using a digital oscilloscope. The system (100) evaluates the wing kinematics of the aerial vehicle (101), where the kinematics of a flapping wing (101b) is evaluated using the kinematic data at simulated space conditions and earth ambient conditions. Further, the system (100) measures the aerodynamic forces and moments of the aerial vehicle (101) in vacuum conditions for a range of flapping frequencies.

The retroreflective markers are installed on the left wing (101b) of the aerial vehicle (101) and is tracked using the motion-capture approach and for various flapping-wing frequencies, time-varying three-dimensional wing kinematics data is acquired.

According to the present invention, the wing form data is projected on a two-dimensional plane to study the wing dynamics behavior. The leading-edge velocity, displacement, acceleration, and wing velocity of the aerial vehicle (101) are evaluated, along with various physical constraints and various position angles of the wing (101j).

Upon evaluation of the parameters, the force measurement is recorded using the load cells and the movement of wings (101b) is evaluated using the motion tracking of flapping wing (101b) through imaging. The velocity, displacement (horizontal and vertical), acceleration of flapping wing (101b) of the aerial vehicle (101) are evaluated. The aerial vehicle (101) accurately replicates the flight motion of the birds in simulated space conditions and the wing kinematics study discloses that, in simulated space conditions, in a range of flapping frequencies, the aerial vehicle (101) operates efficiently in low Reynolds number environments, thus facilitating stable operation in space conditions for planetary exploration.

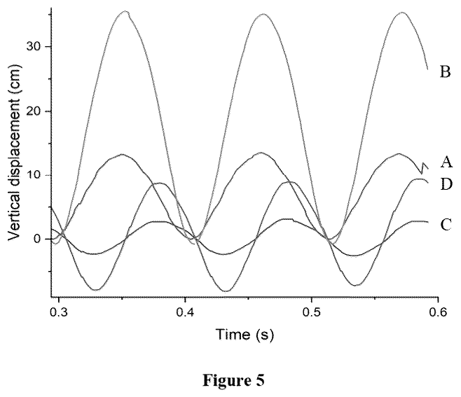

FIG. 5 illustrates a graphical representation of the vertical displacement of the flapping wing (101b) in simulated space conditions and earth ambient conditions. The graphical representation discloses the vertical displacement at Point 1 (P1) in earth conditions represented as A, vertical displacement at Point 2 (P2) in earth conditions represented as B, vertical displacement at Point 1 (P1) in simulated space conditions represented as C and vertical displacement at Point 2 (P2) in simulated space conditions represented as D. The vertical displacement of the flapping wing (101b) in centimeters is measured across time in seconds, and it is seen that there is minimum variation in the vertical displacement in simulated space. conditions and earth ambient conditions. The aerial vehicle (101) resembles the motion of the birds and the coupled vertical movement is similar to the kinematics of a bird's wing (101b), in simulated space conditions.

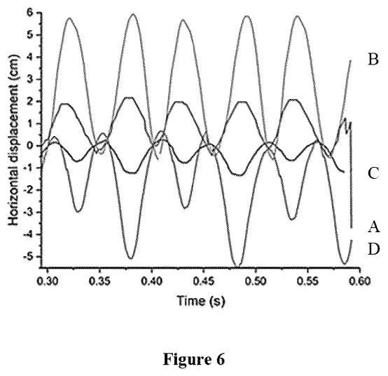

FIG. 6 illustrates a graphical representation of the horizontal displacement of the flapping wing (101j) in simulated space conditions and earth ambient conditions. The graphical representation discloses the horizontal displacement at Point 1 (P1) in earth conditions represented as A, horizontal displacement at Point 2 (P2) in earth conditions represented as B, horizontal displacement at Point 1 (P1) in simulated space conditions represented as C and horizontal displacement at Point 2 (P2) in simulated space conditions represented as D. The horizontal displacement of the flapping wing (101b) in centimeters is measured across time in seconds, and it is seen that there is minimum variation in the horizontal displacement in simulated space conditions and earth ambient conditions. The aerial vehicle (101) resembles the motion of the birds and the coupled horizontal movement is similar to the kinematics of a bird's wing (101b), in simulated space conditions.

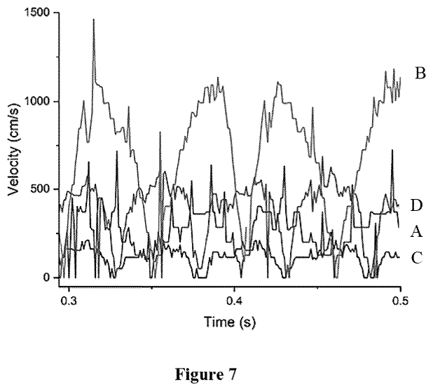

FIG. 7 illustrates a graphical representation of the change in velocity (cm/s) of the flapping wing (101b) vs. time (s) in simulated space conditions and earth ambient conditions. The graphical representation discloses the change in velocity at Point 1 (P1) in earth conditions represented as A, change in velocity at Point 2 (P2) in earth conditions represented as B, change in velocity at Point 1 (P1) in simulated space conditions represented as C and change in velocity at Point 2 (P2) in simulated space conditions represented as D. The change in velocity of the flapping wing (101b) is measured across time, and it is seen that there is minimum variation in the velocity in simulated space conditions and earth ambient conditions. The velocity created by the flapping wing (101b), enables stable flight of the aerial vehicle (101) in simulated space conditions.

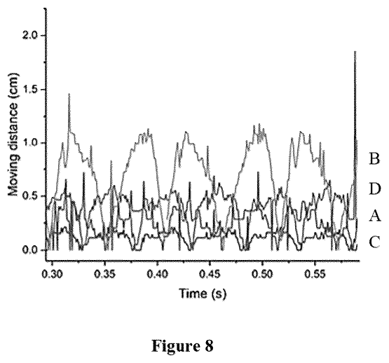

FIG. 8 illustrates a graphical representation of the change in moving distance (cm) of the flapping wing (101b) vs time (s) in simulated space conditions and earth ambient conditions. The graphical representation discloses the change in moving distance at Point 1 (P1) in earth conditions represented as A, change in moving distance at Point 2 (P2) in earth conditions represented as B, change in moving distance at Point 1 (P1) in simulated space conditions represented as C and change in moving distance at Point 2 (P2) in simulated space conditions represented as D. The change in moving distance of the flapping wing (101b) is measured across time, and it is seen that there is minimum variation in the moving distance in simulated space conditions and earth ambient conditions. The moving distance of the flapping wing (101b) in simulated space conditions, enables stable flight of the aerial vehicle (101), mimicking the movement of aerial vehicle (101) in earth conditions.

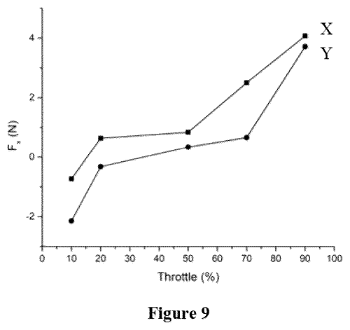

FIG. 9 illustrates the graphical representation of estimation of thrust Force (Fₓ) of the flapping wing (101b) in v and earth ambient conditions. The graphical representation discloses the variation in thrust force in earth conditions represented as X and variation in thrust force in simulated space conditions represented as Y. The thrust force (N of the flapping wing (101b) is measured across throttle (%) and it is seen that the thrust force (Fₓ) generated by the aerial vehicle (101) in simulated space conditions is similar to the thrust force generated in earth ambient conditions.

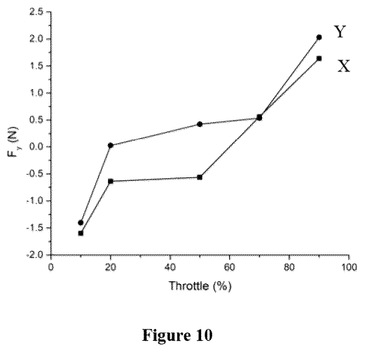

FIG. 10 illustrates the graphical representation of variation of force about y-axis of the flapping wing (101b) in simulated space conditions and earth ambient conditions. The graphical representation discloses the variation in force about y-axis in earth conditions represented as X and variation in force about y-axis in simulated space conditions represented as Y. The force (N) generated by the flapping wing (101b) is measured across throttle (%) and it is seen that the force generated by the aerial vehicle (101) in simulated space conditions is similar to the force generated in earth ambient conditions. The force along y-axis i.e., increases inn thermo-vacuum chamber (103) up to 70% of throttle and then starts to decline compared to earth conditions.

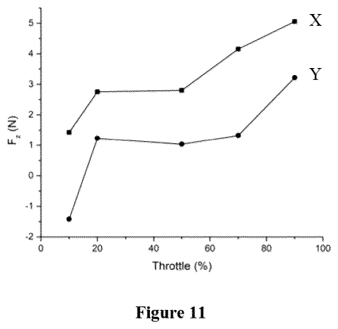

FIG. 11 illustrates the graphical representation of variation of force about z-axis of the flapping wing (101b) in simulated space conditions and earth ambient conditions. The graphical representation discloses the variation in force about z-axis in earth conditions represented as X and variation in force about z-axis in simulated space conditions represented as Y. The force (N) generated by the flapping wing (101b) is measured across throttle (%) and it is seen that force generated by the aerial vehicle (101) in simulated space conditions is similar to the force generated in earth ambient conditions. The lift force i.e., the force along z-axis has less magnitude in simulated space conditions when compared to earth conditions

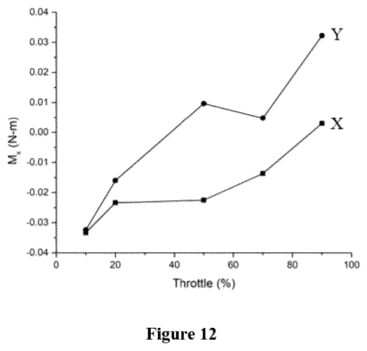

FIG. 12 illustrates the graphical representation of moment about X-axis in simulated space conditions and earth ambient conditions. The graphical representation discloses the moment about X-axis in earth conditions represented as X and moment about X-axis in simulated space conditions represented as Y. The roll i.e., rotation along x-axis) of the flapping wing aerial vehicle (101) continuously increase in simulated space conditions and a sudden change is observed at 70% of throttle value compared to earth conditions.

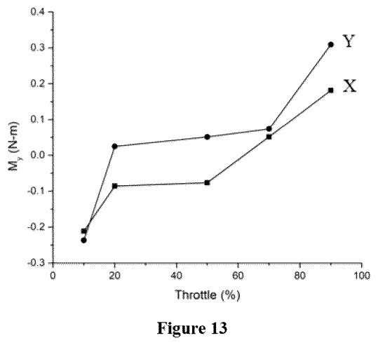

FIG. 13 illustrates the graphical representation of moment about Y-axis in simulated space conditions and earth ambient conditions. The graphical representation discloses the moment about Y-axis in earth conditions represented as X and moment about Y-axis in simulated space conditions represented as Y. The pitch i.e., rotation along Y-axis of the flapping wing aerial vehicle (101) continuously increase in simulated space conditions and a sudden change is observed at 70% of throttle value compared to earth conditions.

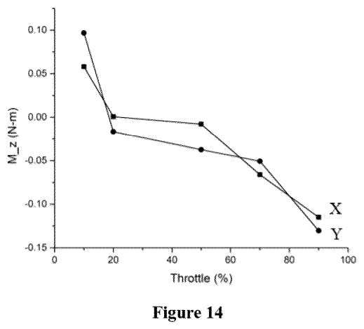

FIG. 14 illustrates the graphical representation of moment about Z-axis in simulated space conditions and earth ambient conditions. The graphical representation discloses the moment about Y-axis in earth conditions represented as X and moment about Y-axis in simulated space conditions represented as Y. The yaw rate i.e., rotation along z-axis of the flapping wing aerial vehicle (101) decreases with increasing throttle value in both ambient earth and vacuum chamber conditions.

According to the present invention, the aerial vehicle (101) exhibits an additional source of lift and thrust in space conditions due to unsteady flow phenomenon caused by the pitching and flapping motion of the wing (101b). The flapping motion of the wing (101b) increases the velocity of the aerial vehicle (101), thus facilitating operation at lower Reynolds number environment. The evaluation of the wing tip provided information that the aerial vehicle (101) resembles the motion of the birds and the coupled vertical and horizontal motions shows similar kinematics as that of a bird's wing.

Further, the aerial vehicle (101) exhibits wing deformation in simulated space conditions that produces high lift forces due to the passive pitch angle of the wing (101b). The pitch angle of the wing (101b) is directly proportional to the frequency of flapping the wing (101b), thus the pitch angle increases with increase in frequency of flapping of the wing (101b). The passive pitching of flapping wing (101b) is achieved with the help of elastic hinges of the wing (101b) and the interaction of the wing (101b) with the surrounding fluid. In a horizontal flight, the flapping motion of the wings (101b) increases the lift at the rear part of the aerial vehicle (101), and also, the flapping motion of both the wings (101b) with a biased amplitude about the pitch axis, the pitch motion of the aerial vehicle (101) is controlled.

According to the present invention, fins of the servo-controlled tail (101c) facilitate balancing, steering, and braking functions of the aerial vehicle (101), and also enhances the lift during low-speed flights. The tail mechanism of the aerial vehicle (101) is designed to exhibit freedom to change roll and pitch functions, thus enhancing the maneuverability of the aerial vehicle (101) during flight.

Additionally, the aerial vehicle (101) also exhibits dynamic wing twisting that maintains the wing (101b) at a specific angle of attack, helping in generation of lift forces. The lift force generated by the flapping wing (101b) is primarily produced during the downstroke, and thrust force is generated in both downstroke and upstroke, in simulated space conditions, wherein the aerodynamic forces produced during the downstroke are highly significant than in upstroke motion of the aerial vehicle (101). The inertial acceleration of the wing (101b) causes the leading edge to bend suggestively around the length of the wing (101b) during the start of the downstroke and upstroke, and a phase lag is created between the root and tip of the wing (101b) throughout the stroke period due to the change in stroke angle along the span of flight.

Further, in the space simulation conditions created by the thermo-vacuum chamber (103), it is observed that the increase in the flapping frequency of the wing (101b) increases the thrust and lift forces. Also, the lift force of the aerial vehicle (101) decreases, as the amplitude of flapping of the wing (101b) decreases. The magnitude of flapping amplitude of the aerial vehicle (101) is higher in simulated space conditions, compared to flapping amplitude in earth ambient conditions.

There are several advantages of the present invention including good propulsion, maneuverability, and harvesting renewable energy. Further, the bioinspired flapping-wing aerial vehicles (101) are suitable for low-altitude surveillance, terrain mapping, swarming capabilities, inspection, and planetary exploration. The aerial vehicle (101) is highly suitable for planetary exploration methods. The aerial vehicles (101) operate efficiently at low Reynolds number environments, thus creating a better aerodynamic behavior.

Further, another advantage of the present invention is that the flapping-wing aerial vehicle (101) are a feasible alternative to helicopters specifically for noise reduction, stealth, and durability while keeping rotary-wing mobility. The pitching and heaving motion of the flapping wing (101b) generates both lift and thrust throughout the flapping stroke. The aerial vehicle (101) is used to harvest renewable energy harvesting with different piezo and tribal materials.

Yet another advantage of the present invention is that the flapping wings (101b) of the aerial vehicle (101) controls the vehicles' motions and generate adequate lift and thrust, and the tail fin on the aerial vehicle (101) provides two degrees of freedom controls i.e., pitching and yawing motions.

Furthermore, the aerial vehicle (101) when used along with the surface rover, facilitates tailoring a prolonged operational altitude to the specific needs of a mission, due to its faster speed. The aerial vehicle (101) that resembles an aerial bird propulsion is suited for operation in low density and low Reynolds number atmospheres, and are advantageous over traditional surface rovers, as they provide airborne observation platforms with a greater field of view. The aerial vehicle (101) aids a rover and explore the surrounding area to create imagery with a higher resolution. As the aerial vehicle (101) is less invasive to a specific place as the vehicle flies higher, the planetary exploration will be contact-free, thus enabling preservation of fragile habitats and microclimates.

Reference numbers

| Components | Reference Numbers |
|---|---|
| Flight performance determination | 100 |
| system | |
| Bioinspired flapping wing aerial | 101 |
| vehicle | |
| Image capturing device | 101a |
| Wing | 101b |
| Servo-controlled tail | 101c |
| Housing | 101d |
| Receiver | 101e |
| Electronic speed controller | 101f |
| Electric motor | 101g |
| Gear drive | 101h |
| Crank arm assembly | 101i |
| Transmission gear and shaft assembly | 101j |
| Electric motor gear | 101k |
| Battery module | 101l |
| Data logging and processing system | 102 |
| Thermo-vacuum chamber | 103 |
| Force transducer | 104 |
| Data acquisition system | 105 |

1. A system for determination of flight performance of the bioinspired flapping-wing aerial vehicle, the system (100) comprising:
a. a bioinspired flapping-wing aerial vehicle (101) comprises:
i. an image capturing device (101a) to facilitate imaging and videography;
ii. at least one wing (101b) which exhibits the flapping motion that uses dynamic wing twisting to maintain the wing (101b) at a specific angle of attack to generate lift;
iii. a servo-controlled tail (101c) to provide enhanced maneuverability to the flapping-wing aerial vehicle (101) and perform balancing, steering, and braking functions that enhances lift of the flapping-wing aerial vehicle (101) during low-speed flights;
iv. a housing (101d) to accommodate at least one payload;
v. a receiver (101e) to receive signal from an electronic speed controller (101f) which controls the speed of the wing (101b) of the bioinspired flapping-wing aerial vehicle (101);
vi. an electric motor (101g) for supplying power to a gear drive (101h) that drives the flapping motion of the wing (101b);
vii. a crank arm assembly (101i) to create an asymmetric flapping angle at the root of the wing (101b);
viii. a transmission gear and shaft assembly (101j) connected to the crank arm assembly (101i) to transmit power from the electric motor (101g) to the wing (101b);
ix. an electric motor gear (101k) powered by a battery module (101l), to facilitate flapping motion of the wing (101b);
b. a data logging and processing unit (102) with at least one channel of analog signals to record the waveform data captured by the image capturing device (101a) and overlay the recorded waveform data onto a video. the system (100), wherein the flapping wing aerial vehicle (101) exhibits a stable operation in low density and low Reynolds number atmosphere with high speed and endurance limit.

2. The system (100) as claimed in claim 1, wherein the flapping-wing aerial vehicle (101) is placed inside a thermo-vacuum chamber (103) which simulates the climatic conditions of space, facilitating evaluation of the kinematics of the flapping-wing aerial vehicle (101) in simulated space conditions in a three-dimensional plane.

3. The system (100) as claimed in claim 1, wherein a force transducer (104) is connected to the thermo-vacuum chamber (103) that converts the input mechanical force of the wing (101b) of the aerial vehicle (101) into current and voltage values, which are acquired by a data acquisition system (105).

4. The system (100) as claimed in claim 1, wherein the kinematics of the wing (101b) is determined at simulated space conditions using the thermo-vacuum chamber (103) and earth's ambient conditions, wherein retroreflective markers are placed on the left wing (101b) and markers are tracked by motion-capture approach at various flapping frequencies.

5. The system (100) as claimed in claim 1, wherein wing data is projected on a two-dimensional plane to evaluate the dynamic behavior of the wing (101b) including leading-edge velocity, displacement, acceleration and wing velocity.

6. A method for determination of flight performance of the bioinspired flapping-wing aerial vehicle (101), the method (200) comprising the steps of:
a. installing the flapping-wing aerial vehicle (101) in the thermo-vacuum chamber (103), wherein the pressure inside the chamber is maintained at pre-defined low pressure, to replicate the conditions of a high vacuum and cold space atmosphere by varying the pressure and temperature in the thermo-vacuum chamber (103) in real-time;
b. studying the lift and thrust forces generated by the flapping-wing aerial vehicle (101) at various frequencies and amplitudes using the image capturing device (101a);
c. evaluating the performance of the force transducer (104) and acquiring its data using data acquisition system (DAQ) (105), and recording the current and voltage values for each test, wherein the voltage values are observed from retroreflective markers placed on the left wing (101b) using a digital oscilloscope;
d. quantifying the force generated by the flapping-wing aerial vehicle (101) and tracking the motion of the flapping-wing aerial vehicle (101) using the image capturing device (101a); and
e. measuring the velocity, horizontal displacement, vertical displacement, acceleration of flapping wings (101b) of the flapping-wing aerial vehicle (101).

7. The method (200) as claimed in claim 6, wherein flapping-wing aerial vehicle (101) exhibits an additional lift and propulsion in simulated space conditions, due to the unstable flow phenomenon caused by pitching and flapping motion of the wing (101b).

8. The method (200) as claimed in claim 6, wherein the flapping wing (101b) of the flapping-wing aerial vehicle (101) in simulated space conditions generates lift force during the downstroke motion and thrust force during downstroke motion and upstroke motion, where the lift and thrust forces produced during the downstroke motion are higher than in upstroke motion.

9. The method (200) as claimed in claim 6, wherein the velocity created by the flapping motion of the wing (101b) increases the local Reynolds number of the wing (101b) and the increase in the flapping frequency of the wing (101b) in simulated space conditions, increasing the thrust and lift forces, where the flapping motion of the wing (101b) increases the lift force at the rear part in horizontal flights

10. The method (200) as claimed in claim 6, wherein the flapping-wing aerial vehicle (101) exhibits, wing deformation in simulated space conditions during which the passive pitch angle produces high lift forces, facilitating stable flight in simulated space conditions, where the passive pitching of the flapping wing (101b) is achieved using the hinges of the wing (101b) and their interaction with the surrounding fluid.

11. The method (200) as claimed in claim 6, wherein the magnitude of thrust force of the flapping-wing aerial vehicle (101) is similar in simulated space conditions and earth ambient conditions and the magnitude of flapping amplitude is higher in simulated space conditions compared to earth ambient conditions.

12. The method (200) as claimed in claim 6, wherein the flapping motion of the wings (101b) with a biased amplitude about the pitch axis and the pitch motion is controlled.
